(19) United States
(12) Patent Application Publication
(10) Pub. No.: US 2022/0388758 A1
(43) Pub. Date: Dec. 8, 2022

(54) Metal foils have non-contact inner space which keep cups and lid to cold/warm

(71) Applicant: Da-Kuang Chang, San Francisco, CA (US)

(72) Inventor: De-Kuang Chang, Taipei (TW)

(21) Appl. No.: 17/300,376

(22) Filed: Jun. 8, 2021

(51) Int. Cl. B65D 81/38; A47G 19/22

(52) U.S. Cl. CPC B65D 81/3869; B65D 81/3874; A47G 19/2288; A47G 19/2205

(57) ABSTRACT

In 2021, major industrial countries announced a 50% carbon reduction in 2030. Disposable paper cups with plastic inner membranes and disposable plastic cups are banned globally are required for recycling and reuse. Double-layer near-vacuum metal foil cups with cold and warm preservation functions, also for keeping cold and warm preservation are Low-carbon market needs.

### TECHNICAL FIELD

The present invention relates to a known cold/warm insulation of cups and lid.

### Previous Technology

At present, the fast food take-out paper cups, PET cups, Styrofoam cups, and plastic lids, which have been used for many years, lack recycling technology and cannot keep warm and cold.

### Utility Patent Content

The present Utility invention is that: In addition to the drinks and pharmaceutical ingredients to achieve prolonged cold/warm insulation. To provide the market with a cup and lid made of a metal foil that can keep warm/cold and meet the requirements of recycling and reuse.

### A SIMPLE DESCRIPTION OF THE SCHEMA

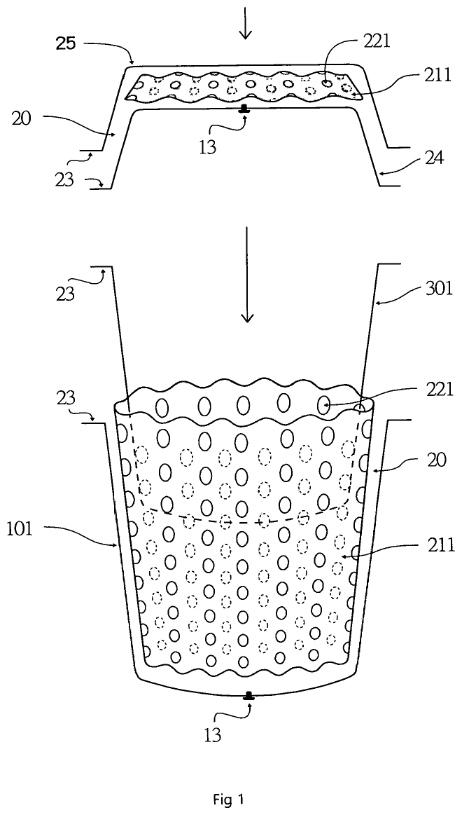

FIG. 1 is a schematic drawing of this creative application applied to a metal foil food and cold/warm beverage cups and lid.

### APPLICATION METHOD

The present invention utilizes a plan perspective view FIG. 1 to a near-vacuum and cold/warm insulating composite material is further described in detail in FIG. 1 by using an iced beverage container and a lid. A metal foil cup made of a cup inner film (301) is used to sheath a cup outer film (101). To make large-size metal foil cups, use a recycled pulp between the inner metal foil cup (301) and the outer metal foil cup (101). Insert a circular wave-shaped multi-hole low-conductivity lining bracket (211) between the inner metal foil cup (301) and the outer foil cup (101). The cup top edge (23) is sealed. A suction valve (13) is heat-sealed at the bottom of the cup (101) to ensure that there is no contact between the inner mezzanine and outer cups after vacuuming. At (221) there is a near-vacuum space. The lids bottom inner film (24) and the top cover outer film (25) shall be placed in the same support frame (211) closed at the cover edge (23). A suction valve (13) is heat-sealed at the bottom of the lid (24). A metal foil cups with lid for food and cold/warm beverage is completed.

The function of the composite metal foil in cold/warm beverage cup application must have a low conductive lining bracket (211), because the inner cup (301) and outer cup (101) foil are too thin to support the near-vacuum space (221) to make the inner cup (301) and the outer cup (101) not contacting each other at the (20) position to achieve the purpose of keeping cold or keeping warm. For a cup-shaped beverage container, when the atmospheric pressure is applied to the outside of the inner cup (301), the outer dimensions of the inner cup (301) will not be changed due to the surface tension of the columnar metal foil. When people choose thicker or higher strength foil for the outer cup (101), the outer cup (101) shape does not change after vacuum, the inner metal foil cup (301) would not make contact with outer foil cup (101), ensure that (20) position would have near vacuum space, then there is no need to have support frame (211) and still achieve the purpose of insulation of keeping cold/warm.

### SYMBOL DESCRIPTION

13 Suction valve.
20 Near-vacuum chamber.
23 Hot-pressing and welding position.
24 Cover bottom.
25 Cover upper.
101 Outer foil cup
211 Round wave with multi-hole low conduction lining bracket.
221 Non-contacting near-vacuum inner space.
301 Metal foil cups.

1. A process for manufacturing a metal foils have non-contact inner space which keep cups and lid to cold/warm as shown in FIG. 1, Its characteristics include:
A recycled pulp with multi-hole wave-shaped low-conductivity round cup support liner (211) is placed between metal foil made inner cup (301) and outer cup (101);
Heat sealed a vacuum valve (13) at the bottom of (101) the metal foil cup and heat-press the top (23) of the cup and vacuum through (13) to complete the construction;
The outer film metal foil cup (101) and the inner film metal foil cup (301), with all holes (221) in the support frame (211), would be of non-contact with each other with near-vacuum space;
The lid must also be inserted with the lining bracket (211) using the same process as previously described;
Heat sealed vacuum valve (13) in the lid rim (23) to heat seal the beverage in the (301) metal foil cup;
Its including the exemption of the (211) support frame;
The use of thicker and stronger materials for the production of the outer cup (101), ensuring that after completion of vacuuming through the (101) outer cup bottom vacuum pumping valve (13) so that there is a non-contact vacuum space (20) between the inner metal foil cup (301) and the outer cup (101), and a inner space with no supporting bracket used in the beverage cup is completed;
A metal foils have non-contact inner space to keep cold/warm used in the food and cold/warm beverage cups and lid assembly is completed.
